(19) United States
(12) Patent Application Publication
(10) Pub. No.: US 2009/0304468 A1
(43) Pub. Date: Dec. 10, 2009

(54) Drill Bit

(76) Inventor: Paul Edward Duggan, Cambridge (GB)

Correspondence Address: NIXON & VANDERHYE, PC, 901 NORTH GLEBE ROAD, 11TH FLOOR, ARLINGTON, VA, 22203, US

(21) Appl. No.: 12/091,194

(22) PCT Filed: Oct. 23, 2006
(86) PCT No.: PCT/GB06/03939

§ 371 Date: Jul. 8, 2008

(30) Foreign Application Priority Data
Oct. 24, 2005 (GB) 0521614.8

(51) Int. Cl. B23B 51/06; B23B 51/04

(52) U.S. Cl. 408/56; 408/207; 408/145; 451/541

(57) ABSTRACT

A drill bit has a cutting face for engaging a workpiece. The cutting face forms an annular cut. A mouth is bounded by the cutting face and receives material of the workpiece from within the annular cut, as cutting progresses. An internal passage has a mouth through which this material can leave the bit.

The present invention relates to drill bits, their construction and manner of use.

Many different designs of drill bits are known, for various purposes. One common requirement for using drill bits arises when tiled surfaces (particularly walls) need to be drilled in order to allow the installation of fixtures in kitchens, bathrooms or the like. For example, cupboards, shelves and sanitary appliances may require fixing to the tiled wall. Drilling tiles in situ is difficult. Great care must be taken to ensure that the tiles do not crack. Some types of tile, particularly hard porcelain tiles and tiles of natural material such as granite, marble etc., are often found sufficiently difficult to drill, or sufficiently expensive to replace if cracked, that a worker may choose to drill the wall only at positions between adjacent tiles, through grout material. This restricts the freedom to position anywhere fixings on the wall, which may be a particular problem when large tiles are in use.

Specialist drill bits for drilling hard tiles, such as porcelain tiles, are found to be expensive and to have a short life.

The present invention provides a drill bit comprising a cutting face for engaging a workpiece to form an annular cut in the workpiece when rotated relative thereto, and a mouth bounded by the cutting face for receiving material of the workpiece from within the annular cut, as cutting progresses.

The cutting face is preferably substantially annular. The cutting face preferably carries granular cutting material. The granular cutting material may be sintered and may be a grit, such as diamond grit or tungsten carbide grit. The granular cutting material may be secured to the cutting face by brazing. The granular cutting material may extend radially beyond the cutting face to form a circumferential edge of cutting material.

Preferably the cutting face has at least one slot formation through which lubricant material may flow, during use, from outside the bit to the annular cut being formed. The or each slot formation is preferably a generally radial slot across the cutting face.

The bit preferably carries at least one formation which serves to feed lubricant material along the bit, to the cutting face, as the bit rotates, in use. The lubricant feed formation is preferably provided on the outer surface of the bit. The lubricant feed formation may be a helical formation. The handedness of the helical formation is preferably opposite to the sense of rotation of the bit, during use. The helical formation is preferably left handed.

The mouth is preferably at the forward end of a passage which extends along the bit to contain workpiece material. The passage may have a rear mouth through which workpiece material is removable from the passage. The rear mouth is preferably transverse to the axis of the bit. The rear mouth may have a longitudinal length which is at least as long as the distance between the forward end of the rear mouth, and the mouth at the forward end of the passage. The width of the rear mouth, transverse to the axis of the bit, is preferably at least as wide as the passage. The passage wall may carry a threaded formation to draw workpiece material toward the rear mouth, as the bit rotates, in use.

The invention also provides a drill bit comprising a cutting face for engaging a workpiece to form an annular cut in the workpiece when rotated relative thereto, and carrying at least one formation which serves to feed lubricant material along the bit, to the cutting face, as the bit rotates, in use.

The drill bit of this aspect of the invention may incorporate any feature or combination of features of the previous aspect of the invention.

In a further aspect, the invention provides apparatus for lubricating a drill bit during use, comprising a lubricant reservoir mounted at a position above the drilling location, and a feed arrangement provided from the reservoir to provide lubricant to the drilling location during use, whereby, in use, lubricant drains from the reservoir to the drilling location.

Preferably the reservoir is releasably mounted, for example by means of a suction device. The feed arrangement may cause lubricant to flow onto the drill bit as it penetrates the workpiece at the drilling location. The lubricant reservoir may be provided by the packaging in which the drill bit is supplied. The feed arrangement may include a valve arrangement operable, in use, to control lubricant flow. The apparatus may include guide means operable to guide the drill bit, during use. There may be collection means for receiving waste material and/or lubricant, during use. The collection means may include an absorbent member for absorbing lubricant material. The apparatus may have a surface of high-friction material which, in use, is placed against the surface being drilled, to resist slippage across the said surface. The reservoir may be provided by the packaging in which the drill bit is supplied.

Examples of the present invention will now be described in more detail, by way of example only, and with reference to the accompanying drawings, in which:

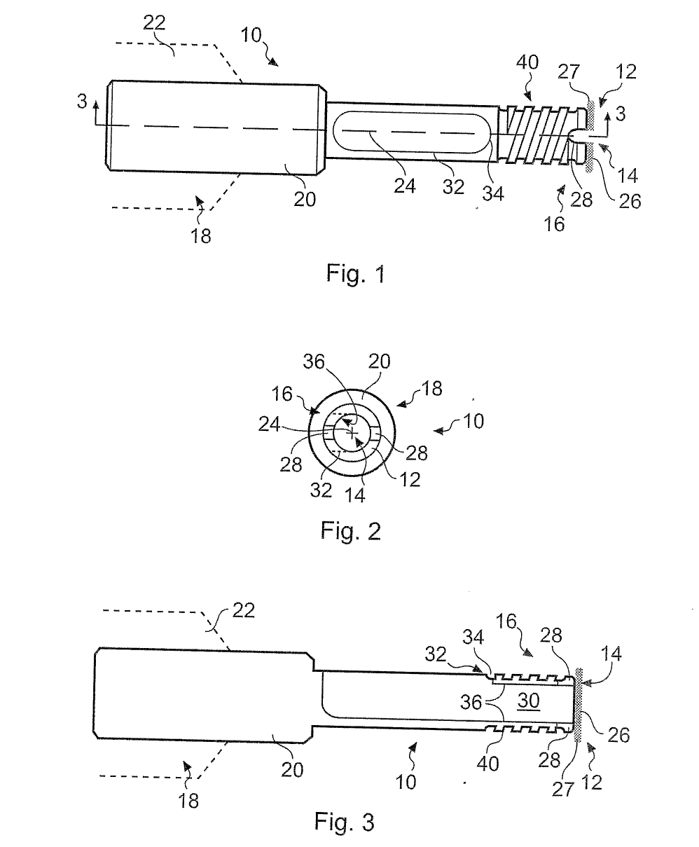

FIG. 1 is a side elevation of a first example of a drill bit of the present invention;

FIG. 2 is an elevation, from the front end, of the drill bit of FIG. 1;

FIG. 3 is a section of FIG. 1, along the line 3-3;

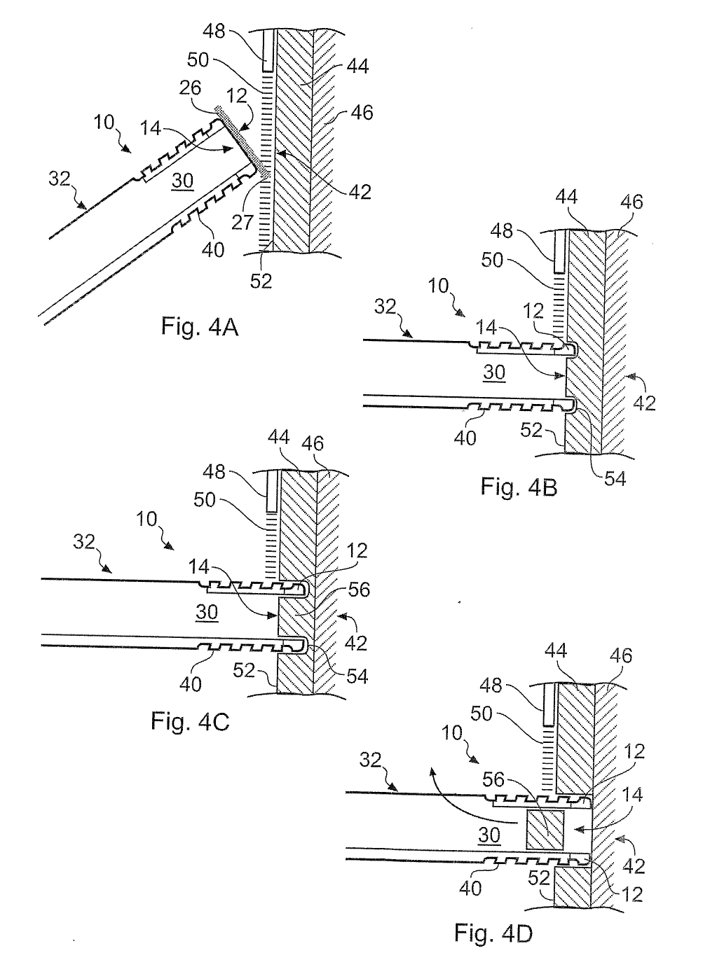

FIGS. 4A to 4D illustrate the manner of use of the drill bit;

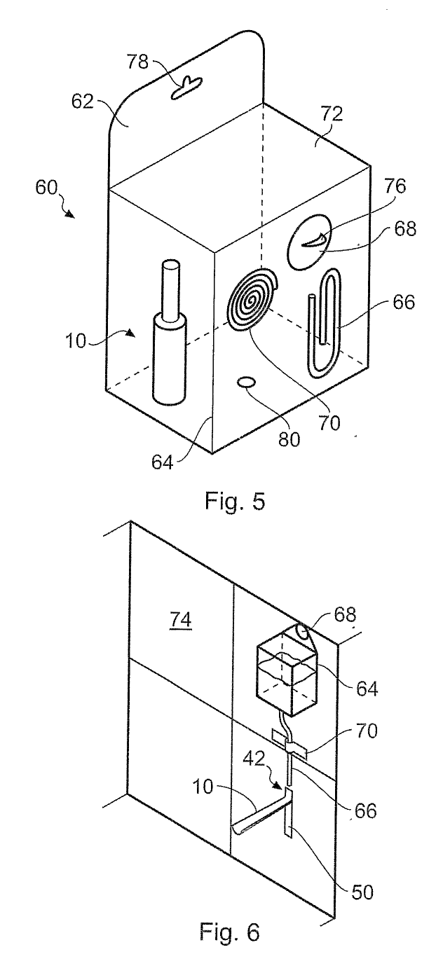

FIG. 5 is a diagram of an example of packaging of the drill bit;

FIG. 6 is an example of the use of the packaging of FIG. 5 for lubricating the drill bit, during use; and

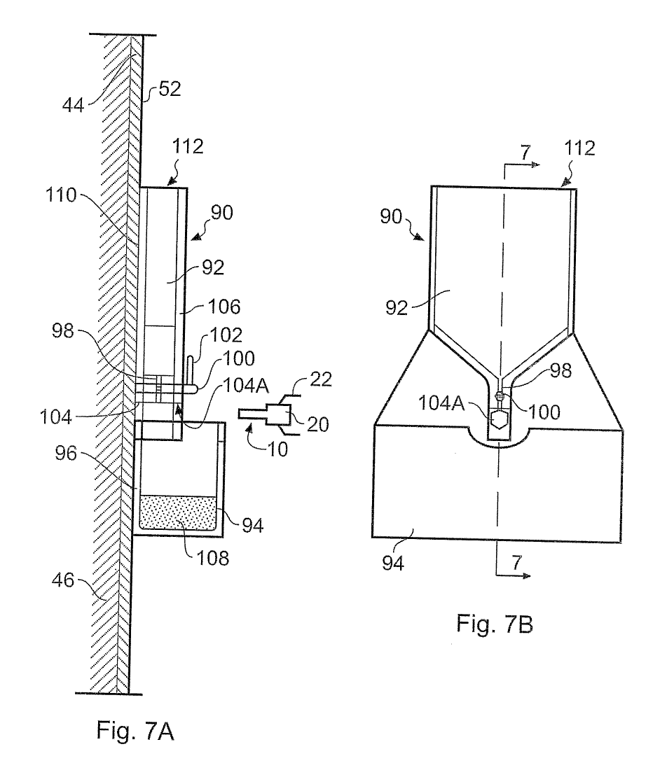

FIGS. 7A and 7B are a vertical section and front elevations of an alternative lubrication arrangement, the section being taken at the line 7-7 of FIG. 7B.

FIGS. 1 to 3 show an example of a drill bit 10 which has a cutting face 12 for engaging a workpiece (not shown in FIGS. 1 to 3). The cutting face 12 forms an annular cut in the workpiece, when rotated relative thereto, as will be described. The drill bit 10 also has a mouth 14 bounded by the cutting face 12 for receiving material of the workpiece from within the annular cut, as cutting progresses, as will be described.

In more detail, the bit 10 is elongate, carrying the cutting face 12 at one end, hereafter termed the forward end generally at 16. At the other end, hereafter termed the back end 18, the bit 10 has a shank 20 by which the bit 10 may be mounted in the chuck 22 of a drill. For use, the chuck 22 is driven to rotate about the axis 24 of the bit 10, thereby turning the bit 10 about the axis and turning the cutting face 12 relative to a workpiece.

The cutting face 12 is substantially annular, as can be seen in particular from FIG. 2. In this example, the cutting face 12 carries a granular cutting material (not shown in FIG. 2). Various materials could be used as cutting materials. Sintered materials could be used. Abrasive grit could be used, such as diamond or tungsten carbide grit. Diamond grit is particularly preferred for the principal intended application of the drill bit being described, namely for drilling hard tiles such as porcelain, granite, marble, slate, stoneware and terracotta tiles.

The granular material 26 is preferably secured to the face 12 by a brazing operation. The ring of granular material 26 extends radially beyond the face 12, as can be seen in FIGS. 1 and 3, providing a circumferential edge 27.

The face 12 preferably has at least one lubricant slot 28. In this example, two slots 28 are provided at diametrically opposite positions. Each extends generally radially across the whole width of the cutting face 12 and has a depth which extends back from the face 12 to a degree sufficient to allow lubricant material to pass through the slot 28 when the face 12 is against a workpiece.

Behind the face 12, a passage 30 extends along the bit 10 toward the shank 20. Thus, the forward end 16 is hollow. In this example, the passage 30 opens transversely to the axis 24, through a rear mouth 32. The longitudinal length of the mouth 32 (that is, the length parallel with the axis 24) is at least as long as the distance from the forward end 34 of the mouth 32 to the mouth 14 at the face 12. In this example, the mouth 32 is longer than this. The width of the mouth 32, in a direction perpendicular to the axis 24, is at least as great as the width or diameter of the passage 30. The internal passage walls 36 may carry a thread or other helical formation (not shown).

The outer surface of the bit 10, between the forward end 34 of the mouth 32, and the face 12, carries a formation which serves, in use, to feed lubricant material along the bit, to the face 12, as the bit rotates. The formation 40 is helical in this example and is a left handed helix. That is, the helix turns anti-clockwise when viewed along the axis 24 and traversed toward the face 12 from the back end 18. It is conventional to drive chucks 22, and thus drill bits, in a clockwise sense when viewed toward the workpiece. Accordingly, the handedness of the helical formation 40 is opposite to the sense of rotation of the bit 10, during use.

The bit 10 can be used in the manner which can now be described with particular reference to FIGS. 4A to 4D.

Initial preparation may include cleaning the drilling location 42, or other preparation of the tile 44. In this example, the tile 44 is in position on a vertical wall 46. A hole is required at the drilling location 42, through the tile 44 and into the wall 46, for example to allow a fixing to be secured at that location.

A supply of lubricant material, which may be water, is provided by allowing the water to flow from a tube 48 down the tile 44, across the drilling location 42. Accordingly, the bit 10 is placed in the flow of lubricant water 50, when offered to the tile 44 at the location 42. The face 12 is therefore wet as it engages the tile 44.

The bit is preferably offered to the tile with the axis 24 at an angle from the perpendicular to the tile face, so that initially, only a short length of the edge 27 rests against the tile surface 52. As the bit 10 starts to turn relative to the tile 44, the edge 27 begins to cut into the tile surface 52, initially forming a short arcuate cut, by virtue of the angle between the bit axis 24 and the tile 44. As cutting progresses, the initial cut becomes deeper and helps hold the bit 10 against slipping across the tile surface 52. The drill and drill bit can then be brought steadily to their final orientation, perpendicular to the tile surface 52, extending the initial cut into a complete annular cut 54 (FIG. 4B). As the cut deepens, a slug 56 of uncut tile material enters the passage 30 through the mouth 14. The slug 56 tends to form a bearing around which the bit 10 will turn, which will maintain the alignment of the bit 10 as the cut progresses.

During this cutting operation, the cutting face 12 remains lubricated by the lubricant water 50, as follows. The water 50 flows down the tile surface 52, onto the outer surface of the bit 10, thus wetting the helical formation 40. As the bit 10 rotates (conventionally in the clockwise sense), the left handed sense of the formation 40 causes water to be drawn into the annular cut 54, in the manner of an Archimedean screw. Thus, lubricant water 50 is fed from the surface 52, into the cut 54, to the face 12. At the face 12, the water 50 may pass through the slots 28, so that lubrication is achieved for substantially the whole of the annular surface over which cutting is taking place.

Eventually (FIG. 4D) the cutting face 12 completes the cut through the tile 44, releasing the slug 56. The slug 56 is then free to pass back down the passage 30 to leave through the rear mouth 32. Movement of the slug 56 back to the rear mouth 32 may be encouraged by providing right hand threads (not shown) on the passage walls 36. The dimensions of the rear mouth 32, particularly the width of the mouth 32, facilitate easy exit of the slug 56 from the passage 30.

Once the bit 10 has cut wholly through the tile 44, it may be removed and replaced by a conventional drill bit for cutting into the wall 46 behind the tile 44. Alternatively, the bit 10 may continue to cut, cutting into the wall 46. However, it is envisaged that the bit 10 would normally be replaced by a conventional bit at this stage, to minimise wear on the bit 10.

Lubrication of the cutting process is preferred for hard tiles. Diamond grit is preferably lubricated with water, during cutting, to reduce wear, over-heating, oxidation and other difficulties. Accordingly, it is desirable to encourage the user to provide adequate lubrication of the bit 10, during use. One example intended to assist in this respect can now be described in more detail, with reference to the remaining figures.

FIG. 5 illustrates a kit of the form in which the drill bit 10 may be sold or supplied. The kit 60 is provided on a backing card 62, in a housing 64, preferably of clear plastics material. This allows the contents of the kit to be inspected before purchase or use. Within the housing 64, the bit 10 is presented along with a length of flexible tube 66, a releasable mount 68, such as a suction cup, and, optionally, a short length of adhesive tape 70. In this example, the housing 64 has an access aperture in its upper face 72, through which the contents of the kit 60 can be removed.

The contents of the kit 60 are installed and used in the manner illustrated in FIG. 6. The suction pad 68 is secured to the tiles 74, above the drilling location 42, and used to hang the housing 64 at that location, for instance by hooking the backing card 62 onto a hook portion 76 of the suction pad 68, by means of a hanging slot 78 in the card 62.

The tube 66 is unrolled. One end is fed into a small aperture 80 in the floor of the housing 64. The tube 66 is then led from the aperture 80 to a position a little above the drilling location 42, and secured in position by means of the adhesive tape 70. The tube 66 may be cut to length, if required.

Finally, just prior to drilling commencing, the housing 64 is filled with lubricant, such as lubricant water 50. Once filled, the lubricant passes into the tube 66 and runs out onto the tiles 74 above the drilling location 42, to be picked up by the bit 10 when drilling commences, as has been described. A clip, valve or other arrangement for closing the tube may be optionally provided.

In an alternative, the housing 64 may contain a small container, such as a flexible bladder, which can be used as a reservoir for lubricant, in place of the housing 64.

FIGS. 7A and 7B illustrate a further alternative for providing lubricant. In these figures, a jig 90 has an upper reservoir 92 mounted with a collection tray 94 on a common back plate 96. The reservoir 92 feeds to a tube 98 which is opened and closed by a simple valve 100 turned by a lever 102. The back plate 96 has an aperture 104 aligned with a corresponding aperture 104A in the outer face 106 of the reservoir 92. The apertures 104, 104A form a guide or jig through which the bit 10 can be introduced, and by which the bit 10 is guided.

The reservoir 92 may include absorbent material such as sponge 108.

The back plate 96 is faced with a high friction material such as a rubber material 110. Alternatively, the back plate 96 may be provided with suction suckers for attachment of the jig 90 to a surface, during use.

The jig 90 may be used in the manner illustrated most simply in FIG. 7A. The jig 90 is offered to the tile surface 52 to position the apertures 104, 104A at the drilling location 42. The reservoir 92 is filled with lubricant material, through its upper mouth 112, with the valve 100 closed. The bit 10 can now be introduced through the apertures 104, 104A to engage the tile 44 at the drilling location 42. Drilling can then commence. During drilling, the bit 10 will be guided by the apertures 104, 104A. The high friction backing 110 (or alternative suckers etc.) resist the jig 90 slipping across the surface 52, thus retaining the bit 10 at the required location 42. It may be preferable for the apertures 104, 104A to engage, primarily or solely, the shank 20 of the bit 10, to avoid interference with the formation 40 or other features of the forward end 16.

Just before drilling commences, the valve 100 is opened to allow lubricant material to begin running from the reservoir 92, down the tube 98 to run onto the bit 10, providing lubrication in the manner described above. Surplus lubricant, or waste lubricant ejected from the hole being drilled, is then able to fall into the tray 94 and be absorbed by the sponge 108, to reduce or prevent spillage. In addition, waste material ejected from the hole being drilled can also be collected by the tray 94.

The jig 90 may be made of transparent material to allow the tile 44 and the hole being drilled to be viewed conveniently by the user, without removing the jig 90.

Accordingly, this arrangement allows a convenient provision of lubricant to the cutting operation, formed only from materials provided to the user with the bit 10 and thus, it is expected that a user is more likely to provide lubrication to the bit 10 than would be the case if the user was required to provide lubrication in some other manner. The lubrication arrangement can readily be moved to another drilling location, if required, by releasing the suction pad 68 and the adhesive tape 70 from the tiles 74, and then installing again at the new location, in the manner described. It is expected that the lubrication components can be sufficiently robust to allow lubrication to continue at further locations until the bit 10 has been worn out.

It will be readily apparent to the skilled reader that many variations and modifications can be made to the examples described above, without departing from the scope of the invention. It may be desirable to omit the mouth 32, allowing the slug of uncut material to leave the passage in an axial direction, from the back end 18. Various different cutting materials can be provided on the cutting face 12. The dimensions and relative dimensions of the bit 10 can be varied considerably, according to the size of hole required, the nature of the material being drilled (particularly the hardness) and the like. Alternatives to suction pads include adhesives, adhesive tapes and the like. Various materials can be chosen for the drill bit, but alloy steels may be used, preferably through hardened and tempered.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A drill bit comprising a cutting face for engaging a workpiece to form an annular cut in the workpiece when rotated relative thereto, and a mouth bounded by the cutting face for receiving material of the workpiece from within the annular cut, as cutting progresses.

2. A drill bit according to claim 1, wherein the cutting face is substantially annular.

3. A drill bit according to claim 1, wherein the cutting face carries granular cutting material.

4. A drill bit according to claim 3, wherein the granular cutting material is sintered.

5. A drill bit according to claim 3, wherein the cutting material is a grit.

6. A drill bit according to claim 5, wherein the grit is diamond or tungsten carbide.

7. A drill bit according to claim 3, wherein the granular cutting material is secured to the cutting face by brazing.

8. A drill bit according to claim 3, wherein the granular cutting material extends radially beyond the cutting face to form a circumferential edge of cutting material.

9. A drill bit according to claim 1, wherein the cutting face has at least one slot formation through which lubricant material may flow, during use, from outside the bit to the annular cut being formed.

10. A drill bit according to claim 9, wherein the or each slot formation is a generally radial slot across the cutting face.

11. A drill bit according to claim 1, wherein the bit carries at least one formation which serves to feed lubricant material along the bit, to the cutting face, as the bit rotates, in use.

12. A drill bit according to claim 11, wherein the lubricant feed formation is provided on the outer surface of the bit.

13. A drill bit according to claim 11, wherein the lubricant feed formation is a helical formation.

14. A drill bit according to claim 13, wherein the handedness of the helical formation is opposite to the sense of rotation of the bit, during use.

15. A drill bit according to claim 13, wherein the helical formation is left handed.

16. A drill bit according to claim 1, wherein the mouth is at the forward end of a passage which extends along the bit to contain workpiece material.

17. A drill bit according to claim 16, wherein the passage has a rear mouth through which workpiece material is removable from the passage.

18. A drill bit according to claim 17, wherein the rear mouth is transverse to the axis of the bit.

19. A drill bit according to claim 17, wherein the rear mouth has a longitudinal length which is at least as long as the distance between the forward end of the rear mouth, and the mouth at the forward end of the passage.

20. A drill bit according to claim 17, wherein the width of the rear mouth, transverse to the axis of the bit, is at least as wide as the passage.

21. A drill bit according to claim 17, wherein the passage wall carries a threaded formation to draw workpiece material toward the rear mouth, as the bit rotates, in use.

22. A drill bit comprising a cutting face for engaging a workpiece to form an annular cut in the workpiece when rotated relative thereto, and carrying at least one formation which serves to feed lubricant material along the bit, to the cutting face, as the bit rotates, in use.

23-24. (canceled)

25. Apparatus for lubricating a drill bit during use, comprising a lubricant reservoir mounted at a position above the drilling location, and a feed arrangement provided from the reservoir to provide lubricant to the drilling location during use, whereby, in use, lubricant drains from the reservoir to the drilling location.

26. Lubricating apparatus according to claim 25, wherein the reservoir is releasably mounted.

27. Lubricating apparatus according to claim 26, wherein the reservoir is mounted by means of a suction device.

28. Lubricating apparatus according to claim 25, wherein the feed arrangement causes lubricant to flow onto the drill bit as it penetrates the workpiece at the drilling location.

29. Lubricating apparatus according to claim 25, wherein the lubricant reservoir is provided by the packaging in which the drill bit is supplied.

30. Lubricating apparatus according to claim 25, wherein the feed arrangement includes a valve arrangement operable, in use, to control lubricant flow.

31. Lubricating apparatus according to claim 25, wherein the apparatus includes guide means operable to guide the drill bit, during use.

32. Lubricating apparatus according to claim 25, wherein collection means are provided for receiving waste material and/or lubricant, during use.

33. Lubricating apparatus according to claim 32, wherein the collection means include an absorbent member for absorbing lubricant material.

34. Lubricating apparatus according to claim 25, wherein the apparatus has a surface of high-friction material which, in use, is placed against the surface being drilled, to resist slippage across the said surface.

35. Lubricating apparatus according to claim 25, wherein the reservoir is provided by the packaging in which the drill bit is supplied.

36-37. (canceled)
